(19) United States
(12) Patent Application Publication
(10) Pub. No.: US 2025/0269608 A1
(43) Pub. Date: Aug. 28, 2025

(54) METHOD FOR FOAM BONDING VIA SURFACE DISSOLUTION AND FOAM LAMINATE THEREFROM

(71) Applicant: Cruz Foam, Inc., Santa Cruz, CA (US)

(72) Inventors: Casey Chandler, Santa Cruz, CA (US); William Thomas Lewczyk, Santa Cruz, CA (US); Nikolas Karolides, Santa Cruz, CA (US); Shelby Oliver, Santa Cruz, CA (US); John Selberg, Santa Cruz, CA (US); Dylan Brown, San Diego, CA (US); Maanas Maheshwari, Saratoga, CA (US); Juan Manuel Bravo, Fairlawn, OH (US); Ryan Tolles, Oak Ridge, NC (US)

(21) Appl. No.: 19/059,942

(22) Filed: Feb. 21, 2025

Related U.S. Application Data
(60) Provisional application No. 63/556,549, filed on Feb. 22, 2024.

(51) Int. Cl. B29C 65/00; B29K 105/04; B32B 5/18; B32B 5/32; B32B 7/10

(52) U.S. Cl. CPC B29C 65/006; B32B 5/18; B32B 5/32; B32B 7/10; B29K 2105/046; B32B 2305/022

(57) ABSTRACT

A method for forming a foam laminate is disclosed. The method comprises applying water to a first surface of a first foam composite to convert the first surface to a solubilized foam layer. A first composition of the first foam composite includes a first material intermixed with a second material. The first material is water-soluble and the second material is water-insoluble. The solubilized foam layer includes dissolved first material corresponding to a portion of the first material at or proximate to the first surface at least partially dissolved by the water. The method further comprises contacting the solubilized foam layer to a second surface of a second foam composite to form a foam stack. The method further comprises dehydrating the solubilized foam layer to solidify the dissolved first material and bond the first foam composite to the second foam composite to form the foam laminate.

### CROSS-REFERENCE TO RELATED APPLICATION

This application claims the benefit of U.S. Provisional Application No. 63/556,549, filed Feb. 22, 2024, which is hereby incorporated by reference in its entirety.

### TECHNICAL FIELD

This disclosure relates generally to foam manufacturing, and in particular but not exclusively, relates to manufacturing of biodegradable foams and foam products therefrom.

### BACKGROUND INFORMATION

Plastic pollution is one of the most pressing environmental issues in modern society. Plastic objects and particles (e.g., plastic bottles, bags, containers, packaging, microbeads, and the like) may accumulate in the environment and adversely affect humans, wildlife, and their habitat. While plastics have achieved ubiquitous use aided by their inexpensive cost and durability, the sheer volume of plastic produced throughout the world results in an unsustainable amount of plastic waste being generated. Additionally, due to the durability, most plastics are resistant to many natural processes of degradation and thus persist within the environment. Plastic waste may be hazardous to life on earth as humans and animals may inadvertently ingest plastic waste and be afflicted by problems related to ingestion, animals may become physically entangled within plastics, and toxic chemicals included in many plastics may leach into water supplies that are used by humans or animals.

Plastics are commonly used in packaging materials, which are inherently wasteful by typically being one time use (e.g., to protect a product being shipped from a manufacturer or retailer to a consumer) while also unlikely to be recycled, meaning most waste from packaging materials ends up in an incinerator, a landfill, or otherwise accumulates in the environment. Plastic foams (e.g., expanded polystyrene) in particular, are regularly used as packaging materials and may significantly contribute to plastic pollution. One avenue to address the ongoing crisis of plastic pollution to replace plastics with more environmentally friendly variants that are biodegradable.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A illustrates a view of a foam laminate obtainable by bonding foam composites together via surface dissolution, in accordance with embodiments of the disclosure.

FIG. 1B illustrates another view of the foam laminate illustrated in FIG. 1A, in accordance with embodiments of the disclosure.

FIG. 1C illustrates an example optical micrograph of a foam laminate, in accordance with embodiments of the disclosure.

FIG. 1D illustrates another example optical micrograph of a foam laminate, in accordance with embodiments of the disclosure.

FIG. 2A illustrates an example method for foam bonding via surface dissolution to form a foam laminate, in accordance with embodiments of the disclosure.

FIG. 2B illustrates an example schematic of the example method of FIG. 2A, in accordance with an embodiment of the disclosure.

FIG. 2C illustrates another example schematic of the example method of FIG. 2A, in accordance with an embodiment of the disclosure.

FIG. 3 illustrates an example chart showing adhesion strength between foam composites included in a foam laminate with respect to bonding technique, in accordance with embodiments of the present disclosure.

FIG. 4 illustrates an example press for applying pressure to a foam stack to form a foam laminate, in accordance with embodiments of the present disclosure.

FIG. 5 illustrates chemical compositions of various ingredients that may be utilized to form foam composites that are biodegradable and included in a foam laminate, in accordance with an embodiment of the disclosure.

FIG. 6 illustrates example foam products formed out of one or more foam laminates, in accordance with embodiments of the disclosure.

### DETAILED DESCRIPTION

Embodiments of a method for foam bonding via surface dissolution and foam laminate therefrom are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In manufacturing articles containing foam, it may be necessary to adhere multiple foam pieces together to obtain the appropriate shape, size, mechanical properties, or the like. Conventionally, one way of adhering foam pieces together is using an external adhesive disposed therebetween (e.g., a spray adhesive, glue, or the like that is of a different composition than the foam pieces). However, conventional adhesives may not necessarily be biodegradable and/or non-toxic and thus may have limited applicability to biodegradable foams. For example, 3M™ Super 77™ spray adhesive is listed as extremely flammable and may cause serious eye irritation, drowsiness or dizziness, damage fertility or the unborn child, and/or damage to organs such as the cardiovascular system.

Described herein are embodiments of a method and foam laminates therefrom that utilize water-induced foam surface dissolution for bonding foam composites together to form a foam laminate. Advantageously, the foam composites include a first material (e.g., a water-soluble and/or hydrophilic component) intermixed with a second material (e.g., a water-insoluble and/or hydrophobic component). When an exterior surface of the foam composites is exposed to water, the first material dissolves, at least in part, or otherwise absorbs/adsorbs water while the second material may remain substantially unaffected by the water and thus may retain the structure of the foam composite or otherwise act as a scaffold. The water-exposed surface of the foam composite consequently becomes a solubilized foam layer that includes the dissolved first material. In some embodiments, the solubilized foam layer is a viscous or gel-like structure that has tack (e.g., adhesive properties) that can be used to bind foam composites together. For example, the surface of a first foam composite may be treated with the appropriate amount of water to convert the surface of the first foam composite to a solubilized foam layer that may be adhered to a second foam composite under the appropriate processing conditions (e.g., applied temperature and/or pressure for a given duration). Over the given duration, the dissolved first material resolidifies as the water evaporates resulting in bonding between the first foam composite and the second foam composite. Advantageously, adhesion between foam composites can be achieved without external adhesives. Rather, the foam composite itself is utilized to form an adhesive layer. Moreover, the techniques described herein, may not significantly disrupt the overall microstructure of the foam composites or otherwise negatively affect the performance (e.g., mechanical and/or thermal properties) as the second material may provide scaffolding when the intermolecular forces bonding the first material are disrupted by the water (e.g., the first material is dissolved), which preserves the mechanical and/or thermal properties of the foam laminate formed by two or more foam composites adhered together. In another aspect of the disclosure, heating may be provided to dehydrate the solubilized foam layer and bond contacting surfaces of the foam composites together. It was found that dielectric heating (e.g., via microwaves) was able to achieve a greater adhesion strength between foam composites adhered together compared to other heating techniques (e.g., radiative heating using hot air). In other embodiments, the solubilized foam layer is dehydrated by thermal radiation (e.g., the first foam composite and/or the second foam composite are preheated or otherwise used while the first foam composite and/or the second foam composite are above a threshold temperature before being treated with water and contacted together). In such an embodiment, “waste” heat from processing (e.g., an extrusion process to form the first and second foam composites) may advantageously be utilized to expedite dehydration of the solubilized foam layer.

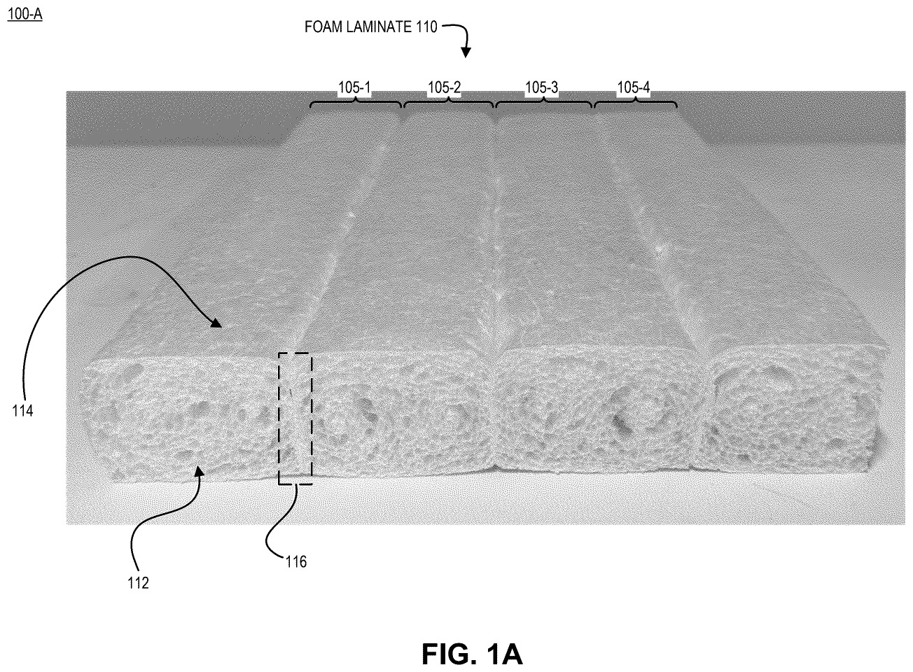

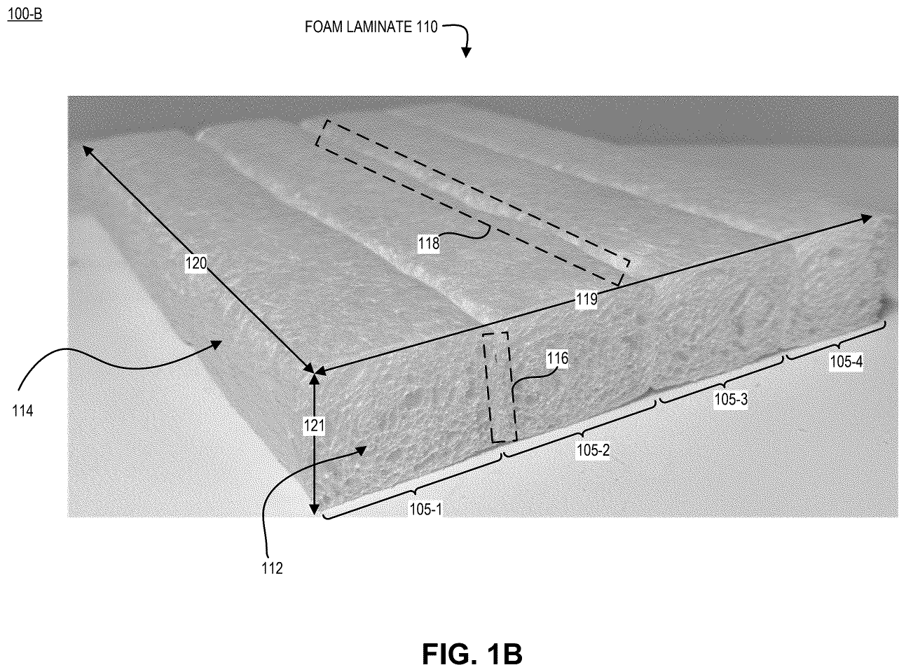

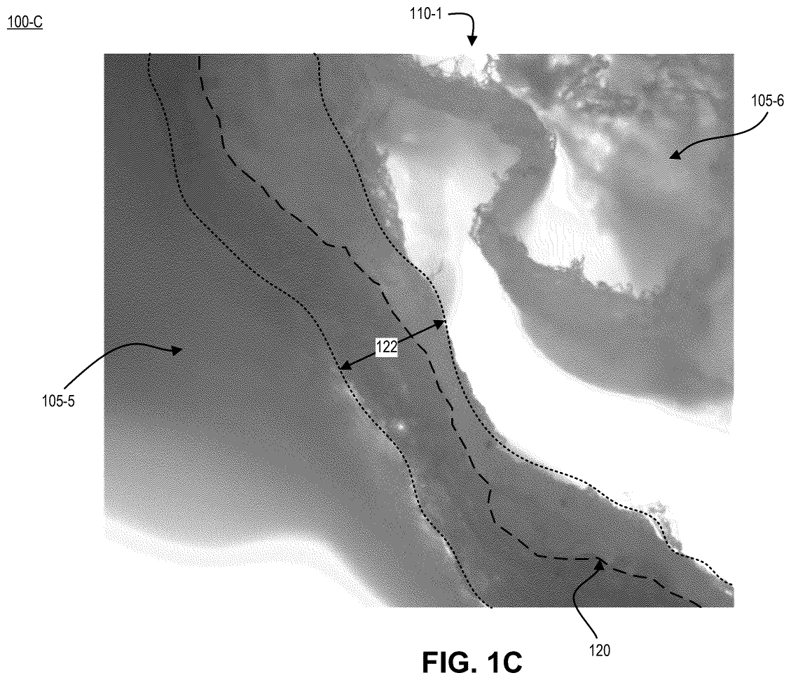

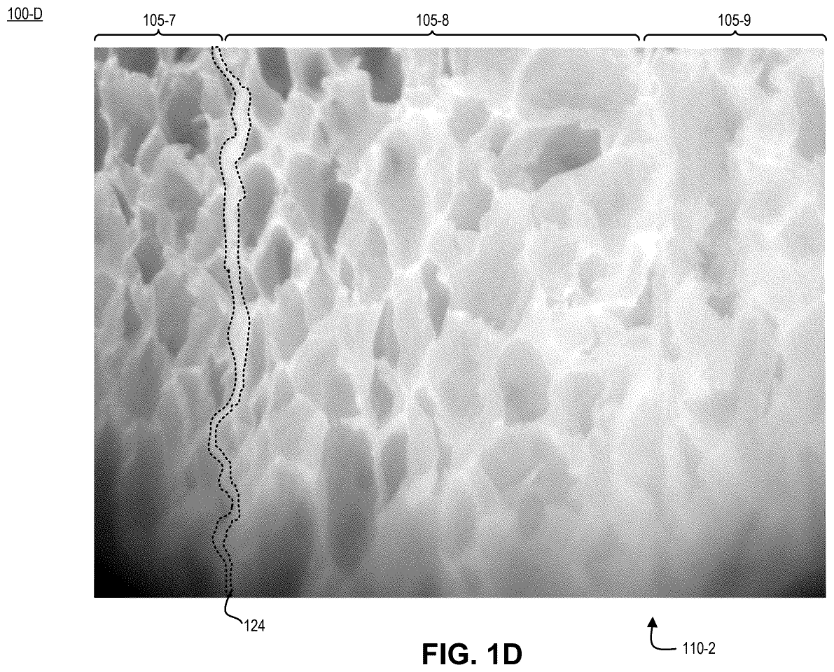

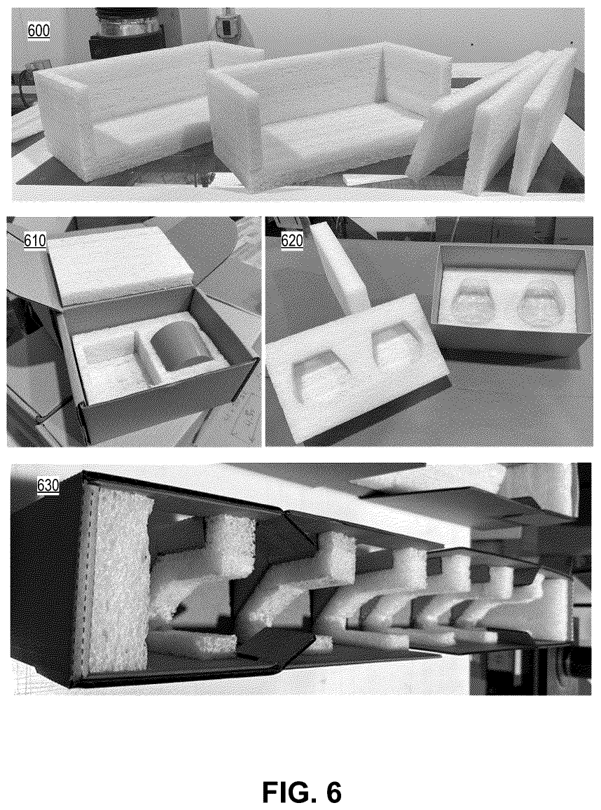

FIG. 1A illustrates a view 100-A of a foam laminate 110 obtainable by bonding foam composites 105 (e.g., 105-1, 105-2, 105-3, and 105-4) together via surface dissolution, in accordance with embodiments of the disclosure. More specifically, the foam composite includes a first composite 105-1, a second foam composite 105-2, a third foam composite 105-3, and a fourth foam composite 105-4 that are each adhered to one or more other foam composites 105. For example, the foam composite 105-2 is bonded or otherwise adhered to the foam composites 105-1 and 105-3 while the foam composite 105-3 is bonded or otherwise adhered to the foam composites 105-2 and 105-4. However, it is appreciated that additional or fewer foam composites 105 may be utilized (e.g., more than or less than four illustrated foam composites) to achieve the desired structure. In the illustrated embodiment, each of the foam composites 105 is characterized as having an open cell structure 112 surrounded by an outer surface 114. In some embodiments, the outer surface 114 is a continuous surface that extends around the foam composites 105 and has a closed cell or closed pore structure, which may be resultant from the method of manufacture (e.g., extrusion). The foam composites 105 are arranged such that foam laminate 110 forms a sheet, but it is appreciated that other geometric shapes may be formed from the foam composites 105. Indeed, the foam composites 105 may be adhered together and/or the foam laminate 110 cut to size to form any suitable structure for its intended use (see, e.g., FIG. 6, for non-limiting example structures).

In some embodiments, the foam laminate 110 has a density, measured under ambient conditions, from 10 kg/m³ to 80 kg/m³, 20 kg/m³ to 80 kg/m³, 30 kg/m³ to 80 kg/m³, 40 kg/m³ to 80 kg/m³, 50 kg/m³ to 80 kg/m³, 60 kg/m³ to 80 kg/m³, 70 kg/m³ to 80 kg/m³, 10 kg/m³ to 80 kg/m³, 10 kg/m³ to 70 kg/m³, 10 kg/m³ to 60 kg/m³, 10 kg/m³ to 50 kg/m³, 10 kg/m³ to 40 kg/m³, 10 kg/m³ to 30 kg/m³, or 10 kg/m³ to 20 kg/m³. In other embodiments, the foam laminate 110 has a density of up to 200 kg/m³. In some embodiments, an unfoamed laminate is produced with the same composition of the foam laminate 110. In such an embodiment, the unfoamed laminate may have a density up to 1300 kg/m³. Referring back to the foam laminate 110, in some embodiments, the open cell structure 112 of the foam composites 105 has an average pore size from 0.5 mm to 4.0 mm μm. In one embodiment, the average pore size of the open cell structure 112 of the foam composite 105 is about (e.g., within 10%) 2 mm. It is appreciated that the average pore size corresponds to an average diameter of pores included in the open cell structure 112. In some embodiments, an average thickness of the outer surface 114 of the foam composites 105 is from 50 μm to 200 μm. In one embodiment, the average thickness of the outer surface 114 of the foam composites 105 is about (e.g., within 10%) 100 μm. In some embodiments, compressive strength of the foam laminate 110 and/or the foam composites 105 at 25% strain is from 1 kPa to 100 kPa. In one embodiment, the compressive strength of the foam laminate 110 and/or the foam composites 105 at 25% strain is about (e.g., within 10%) 1 kPa, 5 kPa, 10 kPa, 20 kPa, 40 kPa, 50 kPa, 70 kPa, or 100 kPa.

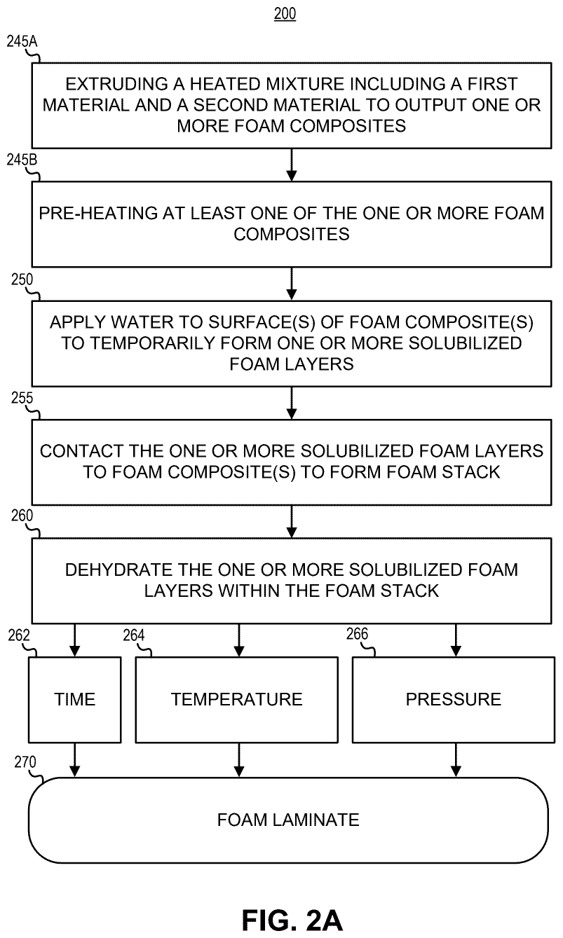

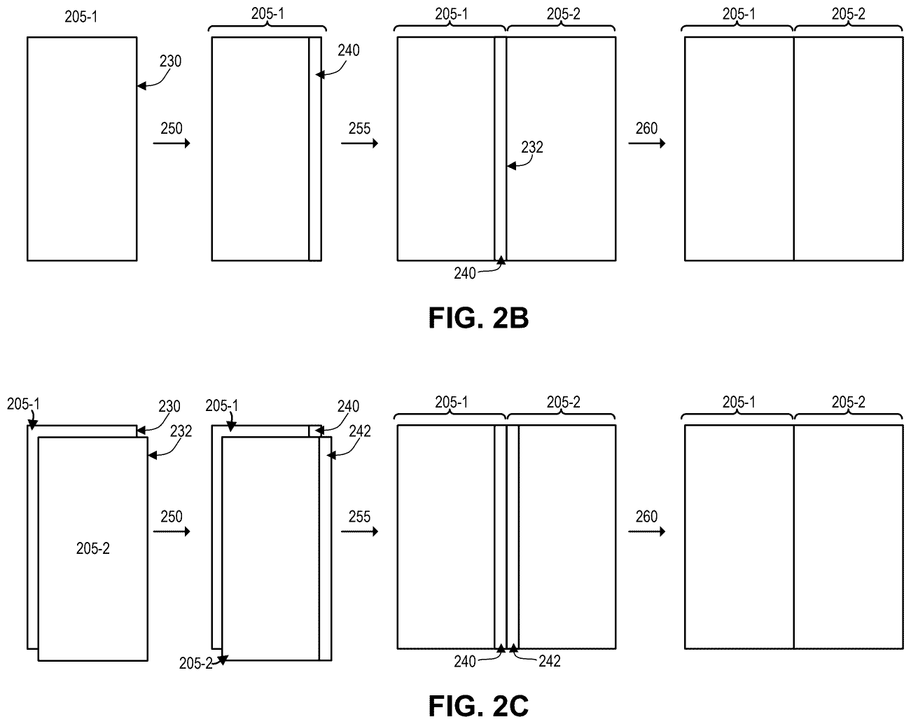

In some embodiments, the outer surface 114 of one or more adjacent foam composites 105 (e.g., the outer surface of foam composite 105-1 and/or foam composite 105-2) may be treated with water (e.g., in the form of a liquid, gas, or aerosol) to partially dissolve the outer surface 114 to form a solubilized foam layer on one or more of the foam composites 105. The solubilized foam layer (see, e.g., FIG. 2B-2C) may be characterized as a viscous, gel-like material with tack. The solubilized foam layer is then used as an adhesion layer to bond the foam composites 105 together (e.g., at interface 116) under the appropriate processing conditions (e.g., time, temperature, and/or pressure). Partial dissolution of the outer surface 114 of the foam composites 105 is achieved, at least in part, based on a composition of the foam composites 105. In some embodiments, each of the foam composites 105 include a first material intermixed with a second material.

In some embodiments, the first material is water-soluble or otherwise a hydrophilic material while the second material is water-insoluble or otherwise a hydrophobic material. In some embodiments, the first material has a water solubility index value of greater than 50% and the second material has a water solubility index value of less than 50% to respectively define the terms water-soluble and water-insoluble. In the same or other embodiments, water contact angle for a drop of water deposited on a surface of a layer of the first material and the second material may be used to characterize the first material and the second material. In one embodiment, a water contact angle for a layer of the first material is less than 70° and a water contact angle for a layer of the second material is greater than 70°. In most embodiments, the first material and the second material are major components (e.g., weight percent of at least 15%) of the foam composites 105. In some embodiments, the first material is from 50% to 80%, by weight, of the foam composites 105 and the second material is from 15% to 40%, by weight, of the foam composites 105. In some embodiments, additional materials (e.g., additives) included in the foam composites 105 are from 3% to 15% by weight. When the outer surface 114 of the foam composites 105 is exposed to water, the first material is at least partially dissolved. For example, the first material may absorb and/or interact with the water, which disrupts the intermolecular forces associated with the first material. For example, in some embodiments, the first material is starch (e.g., unmodified starch such as pea starch, corn starch, or other starches having varying combinations of amylopectin and amylose that have not been chemically modified) while the second material is a biodegradable copolymer (e.g., polybutylene adipate-co-terephthalate or “PBAT”). In some embodiments, the first material, or its constituent components that result from manufacturing of the foam composites 105, are water-soluble while the second material, or its constituent components that result from manufacturing of the foam composites 105, are water-insoluble such that water exposure results in partial dissolution of the foam composites 105 (e.g., the first material is dissolved while the second material is not dissolved and may provide scaffolding and/or mechanical support) and forms the solubilized foam layer. The solubilized foam layer is a partially dissolved foam layer that includes the dissolved first material and may further include the second material, which may or may not be dissolved. However, in most embodiments, the second material is substantially unaffected by the water (e.g., due to the hydrophobic nature of the second material).

Advantageously, the solubilized foam layer can be utilized as a temporary adhesive layer to adhere the foam composites 105 together (e.g., the second foam composite 105-2 is adhered to the first foam composite 105-1). After appropriate processing conditions (e.g., time, temperature, and/or pressure) the solubilized foam layer may be dehydrated to form bonds between the foam composites 105. In other words, no external adhesive is necessary to adhere the foam composites 105 together. It is appreciated that since no external adhesive is utilized to form the foam laminate 110, then the foam laminate 110 has a uniform composition when the foam composites 105 have the same compositions. Thus, in some embodiments the composition of the foam laminate 110, even proximate to the interface 116 disposed between adjacent foam composites (e.g., foam composites 105-1 and 105-2), is consistent throughout. It is appreciated that the uniform composition of the foam laminate 110 may enable the foam laminate 110 to have uniform or consistent mechanical and thermal properties throughout. In some embodiments, during the appropriate processing conditions (e.g., time, temperature, and/or pressure), the first material becomes solubilized/gelatinized in the presence of water and heat. The water diffuses into the foam composites 105 and disrupts the hydrogen bonds between the polymer chains (e.g., of the first material which is hydrophilic). At this point the polymer chains of the first material have some limited mobility and/or ability to reorganize. Upon dehydration, individual polymer chains from adjacent foam layers (e.g., the foam composites 105) can become entangled and/or hydrogen bonds can form between the polymer chains of the first material on adjacent foam composites 105 (e.g., between contacting surfaces of foam composites 105-1 and 105-2) as the water evaporates.

FIG. 1B illustrates another view 100-B of the foam laminate 110 illustrated in FIG. 1A, in accordance with embodiments of the disclosure. The view 100-B shows that the foam laminate 110 is a foam sheet that has a configurable width 119, length 120, and width 121 (e.g., each ranging from centimeters to meters). In some embodiments, multiple foam sheets may be stacked and adhered together to increase the width 121, for example. In some embodiments, the stacked foam sheets can be cut to size to form more intricate shapes or otherwise be arranged to form more complex structures. In the illustrated embodiment, the thickness of the foam laminate 110 is not uniform, rather since each cross-section of the foam composites 105 have a shape correspond to a rectangle or square with rounded corners then an indentation will form at the interface where the foam composites 105 meet. For example, the foam laminate 110 includes an indentation 118 that extends lengthwise (e.g., in a direction of the length 120). The indentation 118 is formed proximate to where the second foam composite 105-2 is adhered to the third foam composite 105-3. However, it is appreciated that in other embodiments, the foam may be cut to size to remove the indentations.

FIG. 1C illustrates an example optical micrograph 100-C of a foam laminate 110-1, in accordance with embodiments of the disclosure. The foam laminate 110-1 is an example of the foam laminate 110 illustrated in FIG. 1A-1B in which two adjacent foam composites 105 have been dyed different colors. In the illustrated embodiment of FIG. 1C, foam composite 105-5 is adhered to foam composite 105-6 without the use of an external adhesive. Rather, a solubilized foam layer was formed by applying water to at least one of the foam composites 105-5 or 105-6 and then the solubilized foam layer was dehydrated in accordance with embodiments of the disclosure to bond the foam composites 105-5 and 105-6 together at interface 120. As illustrated, the interface 122 is a continuous interface adhering the closed pore surfaces of the foam composites 105-5 and 105-6 together. In some embodiments, the continuous interface 120 extends between a closed cell or pore region of the foam laminate 110-1 that has an average thickness from 0.3 mm to 1 mm. In some embodiments, the average thickness of the continuous interface 120 is about (e.g., within 10%) 0.5 mm.

FIG. 1D illustrates another example optical micrograph 100-D of a foam laminate 110-2, in accordance with embodiments of the disclosure. The foam laminate 110-2 is an example of the foam laminate 110 illustrated in FIG. 1A-1B in which three foam composites 105 have been dyed different colors. In the illustrated embodiment of FIG. 1D, foam composite 105-8 is adhered to foam composites 105-7 and 105-9 without the use of an external adhesive, in accordance with embodiments of the disclosure. In the illustrated embodiment, the foam laminate 110-2 forms a continuous interface where adjacent foam composites are bonded together. For example, region 124 is a continuous closed cell or pore region of the foam laminate 110-2 that has an average thickness from 0.3 mm to 1 mm. In some embodiments, the average thickness of the region 124 is about (e.g., within 10%) 0.5 mm. In some embodiments, region 124 (e.g., including a first closed pore surface of foam composite 105-7 contacting a second closed pore surface of foam composite 105-8) forms or otherwise included a continuous interface (e.g., where foam composite 105-7 contacts foam composite 105-8) having a substantially uniform composition corresponding to or otherwise equivalent to a composition of foam composites 105-7 and/or 105-8. In other words, since there is no external adhesive used to adhere the foam composites together the composition across the interface where the two foam composites contact one another is uniform and corresponds to a bulk composition of the foam composites (e.g., after dehydration).

FIG. 2A illustrates an example method 200 for foam bonding via surface dissolution to form a foam laminate, in accordance with embodiments of the disclosure. FIG. 2B-2C illustrated example schematics of the example method 200 of FIG. 2A. The method 200, which includes process blocks 245A, 245B, 250, 255, 260, 262, 264, 266, and 270, may be one possible implementation for fabricating the foam laminate 110, 110-1, and 110-2 illustrated in FIG. 1A-1D. The order in which some or all of the process blocks appear in method 200 should not be deemed limiting. Rather, one of ordinary skill in the art having the benefit of the present disclosure will understand that some of the process blocks may be executed in a variety of orders not illustrated, or even in parallel. It is further appreciated that one or more of process blocks included in process 200 may be omitted in accordance with embodiments of the disclosure.

Block 240A illustrates extruding a heated mixture including a first material and a second material from an extrusion system (e.g., a twin-screw extruder or other extrusion system) to output one or more foam composites (e.g., foam composites 105 illustrated in FIG. 1A, foam composites 205 illustrated in FIG. 2B-2C, or the like). It is appreciated that the heated mixture may include one or more materials, including the first material that is water-soluble or otherwise a hydrophilic material and the second material that is water-insoluble or otherwise a hydrophobic material, to form the one or more foam composites. As will be discussed, an example composition may be based on Table 1. However, in other embodiments, different compositions or material ranges may be used in accordance with embodiments of the disclosure. It is further appreciated that in some embodiments additional materials not listed in Table 1 may be utilized to form the one or more foam composites. In the same or other embodiments, one or more materials illustrated in Table 1 may be omitted. It is further appreciated that extrusion is one example way to form the one or more foam composites, but in other embodiments other techniques may be utilized to form the one or more foam composites (e.g., injection molding).

It is appreciated that in some embodiments, the heated mixture may be output from a die of the extrusion system within a first pre-determined temperature range (e.g., above 80° C. and less than 200° C.) such that the one or more foam composites (e.g., first and second foam composites) exit the extrusion system hot (e.g., at the first pre-determined temperature range). In some embodiments, the one or more foam composites may be allowed to cool until reaching a second pre-determined temperature range (e.g., from 37° C. to 80° C.) that is less than the first pre-determined temperature range. It is appreciated that in some embodiments, the radiant heat output from the one or more foam composites while cooling may be utilized to dehydrate one or more solubilized foam layers within a foam stack (see, e.g., block 260).

Block 245B illustrates pre-heating the one or more foam composites (e.g., the first foam composite and/or the second foam composite) before blocks 250 and 255. Block 245B is an optional block in which radiant heat is utilized to facilitate block 260. In other words, the one or more foam composites may be heated before forming the one or more solubilized foam layers in some embodiments. It is appreciated that the heated foam output from the extrusion system may be subsequently used while hot to expedite the dehydration of the one or more solubilized foam layers discussed in block 260. Advantageously, using the foam while still hot when output from the extrusion system has the benefit of reducing the amount of time necessary to adhere the one or more foam composites together (e.g., by dehydrating the one or more solubilized foam layers within the foam stack as discussed with respect to block 260). In such a manner “excess” or “waste” heat may be utilized to facilitate the formation of the foam laminate. In other embodiments, a heater may be utilized to heat the one or more foam composites (e.g., to the first or second pre-determined temperature ranges) before proceeding the subsequent blocks (e.g., blocks 250 and 255).

It is appreciated that blocks 245A and 245B may be considered complementary process blocks. For example, the extrusion process described in block 245A may result in or otherwise correspond to block 245B. In other words, in some embodiments, when an extrusion process is utilized, the extrusion system itself may provide the pre-heating of block 245B since the one or more foam composites output from the extrusion system will be output at an elevated temperature. However, in other embodiments, process block 245B may supplement or otherwise be provided in lieu of process block 245A such that the one or more foam composites are preheated. In other embodiments, process blocks 245A and 245B may be omitted.

Block 250 shows applying water to one or more surfaces of one or more foam composites to temporarily form one or more solubilized foam layers. In one embodiment, water is applied to a first surface of a first foam composite to convert the first surface to a solubilized foam layer. In some embodiments, the water is also applied to a second surface of the second foam composite to convert the second surface to a second solubilized foam layer. In one embodiment, FIG. 2B illustrates applying water to a first surface 230 of a first foam composite 205-1 to a solubilized foam layer 240. In another embodiment, FIG. 2C shows applying water to the first surface 230 of the foam composite 205-1 and applying additional water to a second surface 232 of a second foam composite 205-2 to respectively form the solubilized foam layer 240 and a second solubilized foam layer 242. It is appreciated that applying the water to the surfaces of one or more foam composites (e.g., the first surface 230 of the first foam composite 205-1 and/or the second surface 232 of the second foam composite 205-2) may be done with water in the form of at least one of a liquid, a gas, or an aerosol.

In some embodiments, the first foam composite and/or the second foam composite include a first material intermixed with a second material. In some embodiments, a first composition of the first foam composite is substantially equal (e.g., constituent component amounts are the same to an extent controllable based on process limitations) to a second composition of the second foam composite. As discussed previously, in some embodiments, the first material is water-soluble and the second material is water-insoluble. Consequently, the solubilized foam layer (e.g., 240 and/or 242 of FIG. 2B-2C) includes dissolved first material corresponding to a portion of the first material at or proximate to the respective surfaces (e.g., surfaces 230 and/or 232 of FIG. 2B-2C) at least partially dissolved by the water. In some embodiments, a specific amount of water may be applied per unit area of the respective surfaces, which may or may not be tied to a composition of the foam composites. In one embodiment, an amount of water applied to one or more of the respective surfaces of the foam composites (e.g., surfaces 230 and/or 232 of FIG. 2B-2C) is from 0.004 g/cm² to 0.01 g/cm². In one embodiment, the amount of water is approximately (e.g., within 10%) 0.005 g/cm². It is appreciated that the dissolved first material may provide varying degrees of tackiness based on the amount of the first material dissolved by the water. Thus, if not enough water is applied to one or more of the respective surfaces of the foam composites, then a solubilized foam layer with suitable adhesive properties may not be foamed and/or the solubilized foam layer may not cover a large enough area to adhere foam composites together. In one embodiment, if the amount of water is 0.003 g/cm² or less, the solubilized foam layer will have insufficient tack and binding the foam composites together becomes difficult. Similarly, if too much water is applied to the respective surfaces of the foam composites, then performance of the foam composites (or more specifically the resulting foam laminate) may degrade as the underlying structure of the foam composites may be disrupted.

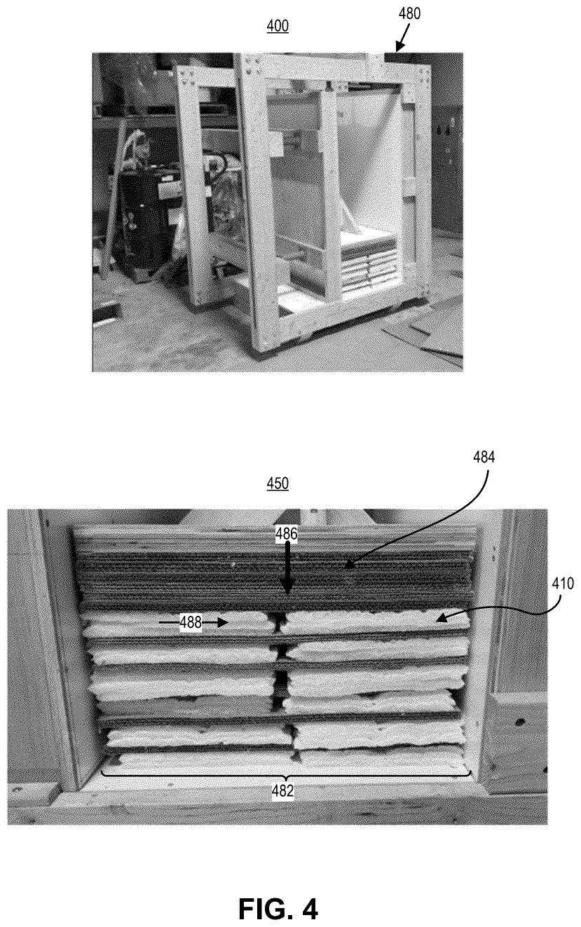

Block 255 shows contacting the one or more solubilized foam layers (e.g., 240 and/or 242 of FIG. 2B-2C) to one or more foam composites to form a foam stack. Specifically, the one or more solubilized foam layers are utilized as a temporary adhesive, which requires physical contact with a conjoining foam composite. In one embodiment, the solubilized foam layer is contacted to a second surface of a second foam composite to form a foam stack. In some embodiments, contacting the solubilized foam layer to the second surface of the second foam composite includes positioning the first foam composite adjacent to the second foam composite along a first direction (e.g., such that pressure can be applied when dehydrating the solubilized foam layer along a second direction perpendicular to the first direction to compress the foam laminate as illustrated in FIG. 4). Referring back to FIG. 2A, the foam stack includes the solubilized foam layer disposed between the first foam composite and the second foam composite. In one embodiment, FIG. 2B illustrates contacting the solubilized foam layer 240 of the first foam composite 205-1 to the second surface 232 of the second foam composite 205-2 to form a foam stack. In such an embodiment, the solubilized foam layer 240 is disposed between the first foam composite 205-1 and the second foam composite 205-2. In another embodiment, FIG. 2C illustrates the solubilized foam layers 240 and 242 converted from the first surface 230 of the first foam composite 205-1 and the second surface 232 of the second foam composite 205-2 are contacted together via block 255. In such an embodiment, the solubilized foam layers 240 and 242 are disposed between the first foam composite 205-1 and the second foam composite 205-2.

Block 260 shows dehydrating the one or more solubilized foam layers (e.g., while the one or more solubilized foam layers are contacting the one or more foam composites to form a foam stack) to bond the foam composite layers together. In some embodiments, dehydrating the one or more solubilized foam layers solidifies the dissolved first material and bonds the first foam composite to the second foam composite to form the foam laminate. In one embodiment, FIG. 2B illustrates block 260 dehydrating the solubilized foam layer 240 to bond the first foam composite 205-1 to the second foam composite 205-2. In another embodiment, FIG. 2C illustrates block 260 dehydrating the solubilized foam layers 240 and 242 to bond the first foam composite 205-1 to the second foam composite 205-2. In some embodiments, the first surface of the first foam composite (e.g., first surface 230 of first foam composite 205-1 illustrated in FIGS. 2B-2C) and/or the second surface of the second foam composite (e.g., second surface 232 of the second foam composite 205-2 illustrated in FIG. 2B-2C) are substantially closed pore surfaces (e.g., an outer “skin” of first foam composite 205-1 and/or second foam composite 205-2 respectively corresponding to first surface 230 and second surface 232 form surfaces that are substantially continuous such that greater than 50% of cells at first surface 230 and/or second surface 232 are closed). In such an embodiment, dehydrating the solubilized foam layer (e.g., solubilized foam layer 240 and/or 242 illustrated in FIG. 2B-2C) forms a continuous interface adhered the closed pore surfaces of the first foam composite and the second foam composite together.

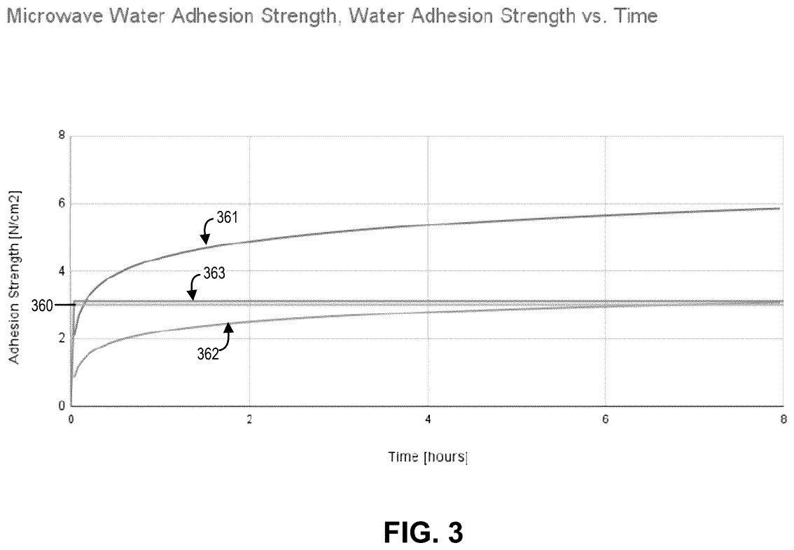

It is appreciated that dehydrating the one or more solubilized foam layers within the foam stack may utilize the appropriate amount of time, temperature, and pressure as indicated by blocks 262-266 to form the foam laminate 270. In some embodiments, dehydrating the solubilized foam layer includes heating the foam stack using at least one of microwaves, radio frequency waves, infrared waves, dry air, or hot air. In other words, non-dielectric heating and/or dielectric heating may be utilized to heat the foam stack. Dehydrating the solubilized foam layers may result in an adhesion strength between two foam composites ranging from 1 N/cm² to 6 N/cm². Depending on the type of heating, it may take from less than a minute (e.g., 30 seconds or less) up to 8 hours to achieve a target adhesion strength between foam composites (see, e.g., FIG. 3 for an example chart showing adhesion strength with respect to heating type). In some embodiments, heating the foam stack includes using radiant heating or dielectric heating to uniformly heat the dissolved first material and adhere the first foam composite to the second foam composite upon solidification of the dissolved first material. Dielectric heating may include, for example, heating with microwaves, radio frequency waves, and/or infrared waves.

It is appreciated that the dielectric heating is direct and may result in increased adhesion strength between foam composites and/or reduced duration needed to achieve a target adhesion strength. For example, microwave heating, as illustrated in FIG. 3, the foam stack may achieve a target adhesion strength within nine minutes while it may take up to seven hours to achieve the same target adhesion strength without microwave heating. In some embodiments, the first material is microwave-sensitive (e.g., is directly heated in response to applied microwaves) while the second material is microwave-insensitive (e.g., is not directly heated in response to applied microwaves). In some embodiments, the dielectric heating results in a target adhesion strength between the first foam composite and the second foam composite of about (e.g., within 10%) 4 N/cm² to about 6 N/cm². In some embodiments, the target adhesion strength is achieved by the dielectric heating in less than 15 minutes, less than 10 minutes, less than 5 minutes, less than 4 minutes, less than 3 minutes, less than 2 minutes, less than 1 minute, or less than 30 seconds. In some embodiments, the duration of the dielectric heating is from 0.1 minutes to 15 minutes. In some embodiments, the dielectric heating is for a first duration, for example less than 1 minute (e.g., 5 seconds to 15 seconds, 5 seconds to 30 seconds, 5 seconds to 60 seconds, 10 seconds to 15 seconds, 10 seconds to 30 seconds, or 10 seconds to 60 seconds), followed by ambient dehydration with or without applied pressure for a second duration (e.g., up to up to 8 hours as illustrated in FIG. 3) to achieve a target adhesion strength. In some embodiments, the target adhesion strength may range from 1 N/cm² to 10 N/cm². In some embodiments, the target adhesion strength is about (e.g., within 10%) 1 N/cm², 2 N/cm², 3 N/cm², 4 N/cm², 5 N/cm², 6 N/cm², or up to 10 N/cm². It is appreciated that an adhesion strength of less than 2 N/cm² may result in the foam laminate delaminating upon handling. Dehydration of the one or more solubilized foam layers within the foam stack may further include applying pressure (e.g., block 266) to the foam stack to ensure contact between adjacent surfaces of the foam composites. In some embodiments, the pressure applied to the foam stacks may range from 5 kPa to 70 kPa. It is appreciated that the pressure may be utilized in lieu of or in addition to the heating over a given duration (e.g., less than 30 seconds up to 10 hours based on block 262).

As discussed previously, in some embodiments radiant heating may be utilized to facilitate dehydrating the one or more solubilized foam layers within the foam stack. It is appreciated that the radiant heating may result in increased adhesion strength between foam composites and/or reduced duration needed to achieve the target adhesion strength. Thus, the “temperature” associated with block 264 may correspond to or otherwise be provided by blocks 245A and/or 245B in some embodiments. For example, process blocks 250-270 may occur while the one or more foam composites are still hot (e.g., from the extrusion process of block 245A and/or the pre-heating process of block 245B) such that the heated foam composites provide radiant heating to dehydrate the one or more solubilized foam layers.

FIG. 3 illustrates an example chart 300 showing adhesion strength between foam composites included in a foam laminate with respect to bonding technique, in accordance with embodiments of the present disclosure. The example chart 300 is representative of a foam laminate (e.g., foam laminates 110, 110-1, and/or 110-2) formed with the method 200 illustrated in FIG. 2A-2C. The adhesion strength is representative of the strength adhering two adjacent foam composites (e.g., any adjacent pair of foam composites 105 illustrated in FIGS. 1A-1D and/or foam composites 205 illustrated in FIGS. 2B-2C). More specifically, the example chart 300 shows adhesion strength with respect to time during and the dehydration (e.g., block 260-266 of the method 200 illustrated in FIG. 2A). The example chart 300 illustrates a threshold adhesion strength 360 (e.g., 3 N/cm²). Line 361 of the example chart 300 shows adhesion strength between two foam composites adhered together when using dielectric heating (e.g., microwave heating) during the dehydration process, line 362 illustrated ambient dehydration (e.g., no heating), while line 363 shows adhesion strength using a reference adhesive (e.g., Thermogrip® 43298 by Bostik). More specifically, line 361 of the example chart 300 includes approximately 15 seconds of microwave heating at 1500 W followed by drying in ambient conditions while line 362 was only dried in ambient conditions. As can be seen from the example chart 300, including dielectric heating in the dehydration process yields improved adhesion strength while reducing the time necessary to complete the dehydration process. For example, target adhesion strength was achieved in 9 minutes with dielectric heating while ambient dehydration required 6.8 hours. In some embodiments, the dielectric heating results in an adhesion strength between the first foam composite and the second foam composite from about (e.g., within 10%) 4 N/cm² 6 N/cm². In the same or another embodiment, a duration to achieve the adhesion strength (e.g., the 4 N/cm² to 6 N/cm²) is from 0.5 minutes to 15 minutes. Accordingly, in some embodiments, the dehydration process includes a first duration for dielectric heating and a second duration for ambient drying. In some embodiments, the first duration is less than 1 minute (e.g., from 5 seconds to 60 seconds) while the second duration is greater than the first duration (e.g., up to 8 hours as illustrated). It is appreciated that the time required to achieve the target adhesion strength can be further improved by increasing the power output by the heating apparatus used to provide dielectric heating.

FIG. 4 illustrates an example press 450 for applying pressure to a foam stack to form a foam laminate 410, in accordance with embodiments of the present disclosure. The foam laminate 410 is one possible implementation of the foam laminates (e.g., foam laminates 110, 110-1, and/or 110-2) formed with the method 200 illustrated in FIG. 2A-2C. In some embodiments, contacting the solubilized foam layer to the second surface of the second foam composite includes positioning the first foam composite adjacent to the second foam composite along a first direction 488. In other words, the foam composites may be placed within a working area 482 of the example press and stacked along the direction 488. Subsequently, the dehydrating the solubilized foam layer includes inserting the foam laminate 410 into the example press 450 and applying a pressure (e.g., 5-70 kPa) in a second direction 486 perpendicular to the first direction 488 to compress the foam laminate 410. It is appreciated that the example press 450 is used to accommodate production of high quantities of laminated sheets of the foam laminate 410. In some embodiments, operation of the example press 450 includes inserting foam composites into the working area 482 after application of water to bonding surfaces with non-bonding surfaces separated by slip-sheets. Then the desired amount of pressure is applied and the foam laminates 410 are left to sit during the dehydration process.

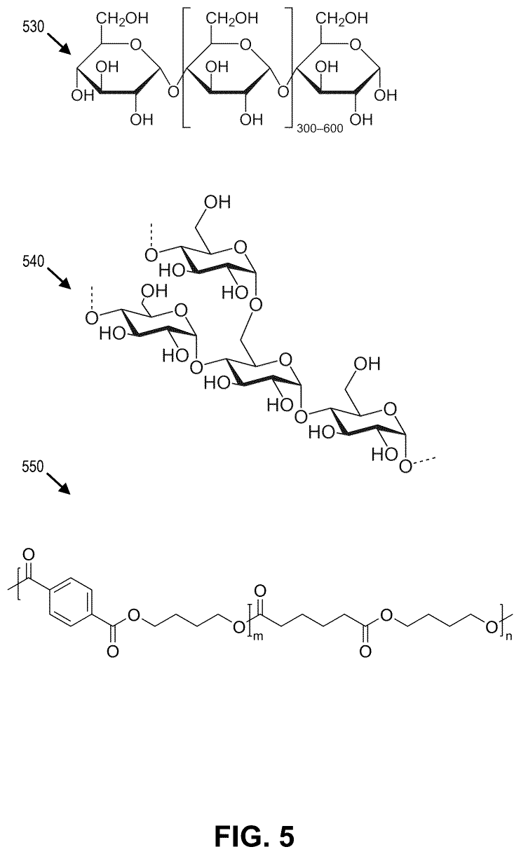

FIG. 5 illustrates chemical compositions of various ingredients that may be utilized to form foam composites that are biodegradable and included in a foam laminate, in accordance with an embodiment of the disclosure. The foam composites (e.g., foam composites 105 illustrated in FIG. 1A-1D, foam composites 205 illustrated in FIG. 2B-2C, or otherwise described throughout the disclosure) may have a respective composition that includes, structure 530 (i.e., amylose), structure 540 (i.e., amylopectin), and structure 550 (i.e., polybutylene adipate-co-terephthalate or PBAT). As previously discussed, the first material may correspond to starch (e.g., unmodified or otherwise) that includes structures 530 and 540 in varying amounts while the second material may correspond to the structure 550 (i.e., PBAT).

More generally, the foam composites and foam laminates formed in embodiments of the disclosure may include unmodified starch (e.g., pea starch, corn starch, or other starches having varying combinations of amylopectin and amylose that have not been chemically modified), a biodegradable copolymer (i.e., polybutylene adipate-co-terephthalate), water, and additional materials. The additional materials may include one or more additional starches (e.g., chitin, chitosan, chitosan oligosaccharide), cellulose, one or more nucleators (e.g., calcium carbonate, talc), one or more plasticizers, (e.g., glycerol, sorbitol, urea, polyvinyl alcohol), one or more lubricants (e.g., glycerol monostearate or other similar ester lubricants, hydrogenated castor wax, glycerol distearate, and glycerol tristearate, a non-hydrogenated natural wax and metal fatty acid derivative blend such as STRUKTOL® V-Wax OP and/or ethylene glycol distearate), acetic acid, one or more processing aids (e.g., a silane-based processing aid such as STRUKTOL® TPW 813, iron oxide pigments, a silane coupling agent, a heat stabilizer, and the like). In general, it is appreciated that the additional materials are inclusive of any material included in the foam composites and foam laminates but for the starch (unmodified or otherwise), the biodegradable copolymer, and water.

Advantageously, in some embodiments, the compositions of the foam composites and foam laminates may be capable of significantly reducing, or outright eliminating, the amount of additional materials. For example, in some embodiments, the additional materials may account for less than 15%, less than 10%, less than 5%, less than 2.5%, or less than 1% of weight percent of the foam composites and foam laminates. In the same or other embodiments, the unmodified starch and the PBAT may effectively plasticize each other during processing such that traditional plasticizers (e.g., glycerol, urea, sorbitol, etc.) may be omitted entirely. For example, in some embodiments, a composition of the foam composites and foam laminates may not have any other polymers (e.g., other than the unmodified starch and the PBAT). It is appreciated that the reduction in the additional materials has the advantage of simplifying processing and reducing cost while maintaining or improving foam performance through a broad range of environments.

In some embodiments, the foam composites and foam laminates may have a composition that has the following material ranges.

TABLE 1
Example material ranges for the
foam composite and foam laminates

| Material | % of formula (w/w) |
|---|---|
| PBAT | 0-50% |
| Starch | 50-90% |
| Chitosan | 0-10% |
| Glycerol Monostearate | 0-5% |
| Calcium Carbonate | 0-3% |
| Talc | 0-15% |
| Urea | 0-30% |
| Glycerol | 0-30% |
| Acetic Acid | 0.1-3% |
| Water | 5-25% |

In some embodiments, the first foam composite has a first material weight percent (e.g., starch weight percent) representative of the first material included in the first foam composite and a second material weight percent (e.g., PBAT weight percent) representative of the second material included in the first foam composite. In one embodiment, the first material weight percent and the second material weight percent are each greater than 20%. In the same or another embodiment, the first material weight percent is greater than the second material weight percent. In some embodiments, the weight percent of PBAT is from 20% to 35%, the weight percent of the chitosan is from 1% to 3%, the weight percent of the starch is from 60% to 80%, the weight percent of the glycerol monostearate is from 0.1% to 1.0%, the weight percent of the talc is from 1% to 5%, the weight percent of the urea is from 5% to 15%, the weight percent of the glycerol is from 0% to 20%, the weight percent of the acetic acid is from 0.1% to 1%, and the weight percent of the water is from 10% to 20%.

It is appreciated that the starch may correspond to the unmodified starch included in the composition of the foam composites and foam laminates. It is further appreciated that the chitosan, glycerol monostearate, calcium carbonate, talc, urea, glycerol, and acetic acid may collectively be referred to as “additional materials” that may be included in the composition of the foam composites and foam laminates. In the same or other embodiments, a PBAT weight percent representative of the PBAT included in the foam is from 10% to 40%. In the same or other embodiments, a starch weight percent representative of the unmodified starch included in the foam composites and foam laminates is greater than the PBAT weight percent. In the same or other embodiments, the starch weight percent is from 50% to 90%. In some embodiments, the starch weight percent and the PBAT weight percent collectively account for 85% to 100% of the composition of the foam composites and foam laminates. In some embodiments, the starch weight percent and the PBAT weight percent collectively account for 90% to 100% of the composition of the foam composites and foam laminates. In the same or other embodiments, a water weight percent representative of the water included in the foam composites and foam laminates is less than each of the PBAT weight percent and the starch weight percent. In some embodiments, the starch weight percent, the PBAT weight percent, and the water weight percent collectively account for 90% to 100% of a composition of the foam composites and foam laminates. In the same or other embodiments, an additional materials weight percent representative of the additional materials included in the foam composites and foam laminates is less than the water weight percent. In some embodiments, the additional materials weight percent is from 0% to 5% (e.g., such that the unmodified starch, the PBAT, and the water collectively represent 95% of a composition of the foam composites and foam laminates). As discussed previously, the additional materials correspond to any other material included in the foam composites and foam laminates but for the unmodified starch, the PBAT, and the water. In some embodiments, the additional materials include at least one of a nucleator, an antioxidant, a lubricant, a plasticizer, or a processing aid. In some embodiments, a composition of the foam composites and foam laminates consists essentially of the unmodified starch, the PBAT, the water, and the additional materials. In the same or other embodiments, the additional materials include at least one of polycaprolactone, polybutylene succinate, polyvinyl alcohol, glycerol monostearate, stearate-based lubricants, silicone-based lubricants, calcium carbonate, talc, glycerol, urea, sorbitol, chitosan, acetic acid, iron oxide pigments, a non-hydrogenated natural wax and metal fatty acid derivative blend, a silane coupling agent, or a heat stabilizer. In the same or other embodiments, a composition of the foam composites and foam laminates is homogeneous. In the same or other embodiments, a corresponding microstructure of the foam composites and foam laminates is single phase.

In embodiments of the disclosure, unmodified starch is defined as a material made of amylose (i.e., structure 530) and amylopectin (i.e., structure 540) that has not been chemically modified. It is appreciated that different types of unmodified starches have different relative amounts of amylose (i.e., structure 530) and amylopectin (i.e., structure 540) content. For example, pea starch may have higher amylose content (e.g., 25% by weight or higher of amylose), which is greater relative to corn starch. In some embodiments, the amount of amylose included in the unmodified starch may be up to 80% depending on the variety of pea starch. It is believed that the linear structure of amylose facilitates better “flow” during processing to allow for proper plasticization and gelation provided the appropriate processing conditions are utilized during extrusion. Accordingly, in some embodiments, the unmodified starch includes an amylose content from 25% to 80%.

Structure 550 corresponds to polybutylene adipate co-terephthalate (PBAT), which is a synthetic biodegradable random copolymer that, in combination with the unmodified starch, form the majority of the composition of the foam composites and foam laminates discussed in embodiments of the disclosure. More specifically, PBAT is a copolyester of adipic acid, 1,4-butanediol, and terephthalic acid. PBAT provides improvements to moisture sensitivity of the foam composites and foam laminates. Additionally, it is believed that the PBAT is capable of compensation for the lack of (or reduction) in a plasticizer when forming the foam composites and foam laminates. It is believed that PBAT flows much easier than the unmodified starch and thus acts as a plasticizer/lubricant. It was found that lowering the amount of PBAT to less than 10%, by weight, of the composition of the foam composites and foam laminates results in over-torquing/over-pressurizing the extruder used to manufacture the foam composites of embodiments of the disclosure. It is appreciated that fabrication of the foam composites may be formed by placing the raw materials (e.g., the first material, the second material, water, and optionally the “additional materials”) into an extruder, which heats and mixed the raw materials under pressure to produce a foam output by the extruder as an extrudate that corresponds to the foam composites. In some embodiments, the raw materials may be preprocessed by the extruder to produce unfoamed granules that may be later processed (e.g., foamed) by the extruder to form the foam composites.

It is appreciated that embodiments of the disclosure use water to partially dissolve the first material in the foam composites. However, in other embodiments, a solvent other than water may be utilized to selectively dissolve the surface of the foam composite in a controllable manner to produce a tacky interface for adhesion (i.e., the solubilized foam layer). In such an embodiment, dimethyl sulfoxide, potassium hydroxide, sodium hydroxide, or other solvents of the first material may be utilized instead of water. It is noted that dissolution/gelatinization of the first material (e.g., starch including, but not limited to, unmodified starches such as pea starch, cornstarch, potato starch, other starches, or combinations thereof) provides the tack of the solubilized foam layer while the second material (e.g., PBAT) provides the scaffold to maintain the structure of the solubilized foam layer. It was further found that using a solvent targeting dissolution of the second material does not result in a solubilized foam layer with tackiness.

FIG. 6 illustrates example foam products 600, 610, 620, and 630 formed out of one or more foam laminates, in accordance with embodiments of the disclosure. The example foam products 600, 610, 620, and 630 may be fabricated by the foam laminates 110, 110-1, and/or 110-2 illustrated in FIGS. 1-1D and other embodiments of foam laminates discussed throughout the disclosure. Specifically, the foam laminates may be die cut and stacked to form the example foam products 600, 610, 620, and 630. It is noted that the illustrated foam products 600, 610, 620, and 630 are non-limiting and that other shapes, structures, geometries, and the like may be utilized to form a foam product that meets a target size and shape. In some embodiments, die cut foam may be combined with die cut corrugate to maximize the rigidity of the corrugate with the compressive strength of the foam for an optimum packaging solution. In the same or other embodiments, the foam may be cut and heat pressed into shape. In some embodiments, the method 200 may be utilized to adhere the foam composites to materials other than foam (e.g., cardboard). In such an embodiment, the foam laminate to be adhered to the cardboard may be treated with water to generate a solubilized foam layer, which is then contacted to the cardboard. The solubilized foam layer may then be dehydrated to bond the foam composite to the cardboard, in accordance with embodiments of the disclosure.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method for forming a foam laminate, the method comprising:
applying water to a first surface of a first foam composite to convert the first surface to a solubilized foam layer, wherein a first composition of the first foam composite includes a first material intermixed with a second material, wherein the first material is water-soluble and the second material is water-insoluble, and wherein the solubilized foam layer includes dissolved first material corresponding to a portion of the first material at or proximate to the first surface at least partially dissolved by the water;
contacting the solubilized foam layer to a second surface of a second foam composite to form a foam stack, wherein the foam stack includes the solubilized foam layer disposed between the first foam composite and the second foam composite; and
dehydrating the solubilized foam layer to solidify the dissolved first material and bond the first foam composite to the second foam composite to form the foam laminate, and wherein a density of the foam laminate is from 10 kg/m3 to 80 kg/m³.

2. The method of claim 1, wherein the first foam composite has a first material weight percent representative of the first material included in the first foam composite and a second material weight percent representative of the second material included in the first foam composite, wherein the first material weight percent and the second material weight percent are each greater than 15%, and wherein the first material weight percent is greater than the second material weight percent.

3. The method of claim 2, wherein a first composition of the first foam composite is substantially equal to a second composition of the second foam composite.

4. The method of claim 1, wherein the first surface of the first foam composite and the second surface of the second foam composite are each substantially closed pore surfaces, wherein the dehydrating the solubilized foam layer forms a continuous interface adhering the closed pore surfaces of the first foam composite and the second foam composite together.

5. The method of claim 4, wherein the continuous interface extends between a closed pore region of the foam laminate that has an average thickness from 0.3 mm to 1 mm.

6. The method of claim 1, wherein the dehydrating the solubilized foam layer includes heating the foam stack using dielectric heating or radiant heating to heat the dissolved first material and adhere the first foam composite to the second foam composite upon solidification of the dissolved first material.

7. The method of claim 6, wherein the dielectric heating corresponds to microwave heating, wherein the first material is microwave-sensitive and the second material is microwave-insensitive.

8. The method of claim 6, wherein an adhesion strength between the first foam composite and the second foam composite is from about 1 N/cm² to about 6 N/cm² after the dehydrating the solubilized foam layer.

9. The method of claim 1, further comprising pre-heating at least one of the first foam composite or the second foam composite before the applying the water and before the contacting the solubilized foam layer, and
wherein radiant heating from the pre-heated first foam composite or the second foam composite facilitates the dehydrating the solubilized foam layer.

10. The method of claim 9, extruding a heated mixture including the first material and the second material from an extrusion system to output the first foam composite pre-heated based on a temperature of the heated mixture.

11. The method of claim 1, wherein the water is applied to the first surface of the first foam composite in the form of at least one of a liquid, a gas, or an aerosol.

12. The method of claim 1, wherein the contacting the solubilized foam layer to the second surface of the second foam composite includes positioning the first foam composite adjacent to the second foam composite along a first direction, and wherein the dehydrating the solubilized foam layer includes applying a pressure in a second direction perpendicular to the first direction to compress the foam laminate.

13. The method of claim 12, wherein the pressure is from 5 kPa to 70 kPa, and wherein an amount of the water applied to the first surface of the first foam composite is from 0.004 g/cm² to 0.01 g/cm².

14. The method of claim 1, further comprising applying additional water to the second surface before the contacting, wherein a second composition of the second foam composite is substantially equal to the first composition of the first foam composite.

15. A method for forming a foam laminate, the method comprising:
applying water to a first surface of a first foam composite to convert the first surface to a solubilized foam layer, wherein a first composition of the first foam composite includes a first material intermixed with a second material, wherein the first material is water-soluble and the second material is water-insoluble, and wherein the solubilized foam layer includes dissolved first material corresponding to a portion of the first material at or proximate to the first surface at least partially dissolved by the water;
contacting the solubilized foam layer to a second surface of a backing layer to form a foam stack, wherein the foam stack includes the solubilized foam layer disposed between the first foam composite and the backing layer; and
dehydrating the solubilized foam layer to solidify the dissolved first material and bond the first foam composite to the backing layer to form the foam laminate, and wherein a density of the first foam composite is from 10 kg/m3 to 80 kg/m³.

16. The method of claim 15, wherein the backing layer includes cardboard.

17. The method of claim 15, wherein the dehydrating the solubilized foam layer includes heating the foam stack using dielectric heating or radiant heating to heat the dissolved first material and adhere the first foam composite to the backing layer upon solidification of the dissolved first material.

18. The method of claim 15, further comprising pre-heating the first foam composite before the applying the water and before the contacting the solubilized foam layer, and
wherein radiant heating from the pre-heated first foam composite facilitates the dehydrating the solubilized foam layer.

19. The method of claim 18, further comprising extruding a heated mixture including the first material and the second material from an extrusion system to output the first foam composite pre-heated based on a temperature of the heated mixture.

20. A foam laminate, comprising:
a first foam composite, wherein a first composition of the first foam composite includes a first material intermixed with a second material, wherein the first material is water-soluble and the second material is water-insoluble; and
a second foam composite adhered to the first foam composite, wherein a first closed pore surface of the first foam composite directly contacts a second closed pore surface of the second foam composite, wherein the first closed pore surface of the first foam composite and the second closed pore surface of the second foam composite form a continuous interface having a substantially uniform composition corresponding to the first composition.

21. The foam laminate of claim 20, wherein the first foam composite has a first material weight percent representative of the first material included in the first foam composite and a second material weight percent representative of the second material included in the first foam composite, wherein the first material weight percent and the second material weight percent are each greater than 15%, and wherein the first material weight percent is greater than the second material weight percent.

22. The foam laminate of claim 20, wherein an adhesion strength between the first foam composite and the second foam composite is from about 1 N/cm² to about 6 N/cm².
